(19) United States
(12) Patent Application Publication
(10) Pub. No.: US 2010/0228582 A1
(43) Pub. Date: Sep. 9, 2010

(54) SYSTEM AND METHOD FOR CONTEXTUAL ADVERTISING BASED ON STATUS MESSAGES

(75) Inventors: Simon P. King, Berkeley, CA (US); Carrie Burgener, Mountainview, CA (US); Christopher T. Paretti, San Francisco, CA (US); Marc Eliot Davis, San Francisco, CA (US); Rahul Nair, Sunnyvale, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 12/399,669

(22) Filed: Mar. 6, 2009

(51) Int. Cl. G06Q 30/00; G06N 7/02; G06Q 10/00

(52) U.S. Cl. 705/7; 706/52; 705/14.66

(57) ABSTRACT

A system and method for contextual advertising based on status messages. A plurality of status messages sent to a user via at least one socially aware messaging service are retrieved where the user is a member of the socially aware messaging service, has defined at least one social contact on the service, and where each of status messages was sent to the user by one of the user's social contacts. The status messages are analyzed to determine the user's status update context, where the user's status update context comprises a set of social, topical, spatial and temporal data present in the messages. The user's status update context is matched to targeted advertisements. The user's status update context is matched to the targeting criteria of targeted advertisements. Matched advertisements are transmitted to the user.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to systems and methods for improving the effectiveness web based advertising and more particularly, to systems and methods for using status messages to deliver targeted advertisements.

### BACKGROUND OF THE INVENTION

Web based advertising systems commonly attempt to gather as much information as possible about users current contexts in order to deliver targeted advertisements. Traditionally, the most successful form of contextual advertising are “search ads” which consist of ads based on the keywords that a user types into a search query. The ads are based on the user's “search context” and are generally very relevant because the user has expressed a concrete interest in the topic by explicitly searching for it.

There is much information relating to users, however, that remains untapped. As the social web grows, people are spending more and more time browsing the social web where they do not explicitly express interest. One common example of this is microblogging services like twitter and status messages within social networks like FaceBook. Users spend a lot of time reading the status messages from their contacts during which time they are not expressing any interest in any particular area. These status messages can provide a great deal of information about a user's status update context that could be used for contextual advertising.

### SUMMARY OF THE INVENTION

In one embodiment, the invention is a method and a computer-readable medium having computer-executable instructions for a method. A plurality of status messages sent to a user via at least one socially aware messaging service are retrieved, where the user is a member of the socially aware messaging service and has defined at least one social contact to the service, and where each of status messages was sent to the user by one of the user's social contacts. The plurality of status messages are analyzed, using at least one computing device, to determine the user's status update context, where the user's status update context comprises a set of social, topical, spatial and temporal data present in the plurality of status messages. The user's status update context is matched, using the computing device, to at least one targeted advertisement stored on a computer-readable medium. Matched advertisements are transmitted, over the network, to the user.

In one embodiment, the invention is a system comprising: a message retrieval module that retrieves, over a network, a plurality of status messages sent to a user via at least one socially aware messaging service, where the user is a member of the one socially aware messaging services and has defined at least one social contact on the one socially aware messaging services, and where each of the status messages was sent to the user by one of user's social contacts; a message analysis module that analyzes the status messages retrieved by the message retrieval module to determine the user's status update context, wherein the user's status update context comprises a set of social, topical, spatial and temporal data present in the status messages; an advertisement matching module that matches the user's status update context determined by the message analysis module to at least one targeted advertisements stored on a computer-readable medium; and an advertisement transmission module that transmits the at least one targeted advertisement, over the network, to the user.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 is a high level diagram illustrating the components of a system capable of supporting at least one embodiment of a status message based contextual advertising system.

FIG. 2 illustrates one embodiment of a process status message based contextual advertising.

FIG. 3 illustrates one embodiment of a status update context advertising engine 2000 which is capable of supporting the status message based contextual advertising process illustrated in FIG. 2.

### DETAILED DESCRIPTION

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure the term “end user” or “user” should be understood to refer to a consumer of data supplied by a data provider. By way of example, and not limitation, the term “end user” can refer to a person who receives data provided by the data provider over the Internet in a browser session, or can refer to an automated software application which receives the data and stores or processes the data.

For the purposes of this disclosure, a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which can be used to store the desired information and which can be accessed by the computer.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may grouped into an engine or an application.

The present invention is directed to systems and methods for directing targeting advertisements to users based on user's social context as revealed by the user's status update context in which the user's status update context is determined using status messages sent to, or sent by the user. In one embodiment, the advertisements are triggered by the user's own status message and/or the status messages of their contacts.

A user's social context can be defined, without limitation, as the total set of persons with which the user has some form of relationship. A user's social contacts can represent a significant source of information about the user's potential interests, as well as the influences surrounding a user that would not otherwise be available. A user's social contacts can be determined, at least in part, by analyzing contacts a user explicitly lists on social networking websites such as Facebook and MySpace or other socially aware messaging services.

A user's profile information, and the profile information for his or her contacts can reveal a great deal about the user's social context, but even more information can be gleaned from the status messages sent between a user and the user's social contacts. Even if a user utilizes one or more social networking services or other services that allow a user to send or receive status messages, but rarely enters status messages, status messages sent by the user contacts provides insight into the user's social context. If a user's social contacts on a social networking site frequently broadcast status messages about a specific topic, it is more likely the user has a similar interest in that topic or will form an interest in that topic sometime in the future.

More information can be gathered by analyzing patterns of communications between a user and his or her social contacts. For example, status messages sent by a user to the user's social circle can be given greater weight than messages received by the user. Messages to which a user replies can be given greater weight. Messages from contacts with whom the user frequently exchanges messages can be given greater weight. Messages from contacts which appear to have similar interests to the user based on message content can be given greater weight.

More information yet can gathered by analyzing spatial, temporal, demographic, and topical features about a user's contacts that is available via the web, including profile data available on social web sites, BLOGs, as well as the nature of the stated relationships between users on social networking sites. For example, contacts which are demographically similar to the user may be given greater weight. Contacts explicitly listed as friends can be given greater weight than contacts listed as business contacts. Contacts currently located in the same geographical area could be given greater weight than those in a remote area.

Such status update context data can then be used to direct targeted advertisements to a user in a suitable manner, such as display advertisements on a web page, a flash advertisement overlay, emails or status messages.

In one embodiment, advertisements are can be solely based on status messages that a user receives. For example, if a user has an account with the Twitter messaging service, and the user receives a significant number of messages referring to sports cars, the user can be sent advertisements relating to sports cars. The user may never enter a message into the service, but the messages the user receives strongly suggest that the user has friends or acquaintances that have a strong interest in sports cars. This implies that the user may have, or will form, an interest in sports cars.

Such targeted advertising could be used compete with a specific brand or product. For example, if a user receives a number of messages regarding running shoes made by Nike, the user could be sent targeted ads for New Balance brand running shoes. The user may never enter a message into the service, but the messages the user receives strongly suggest that the user has friends or acquaintances that own Nike brand running shoes, and who may not be aware of the features or advantages of New Balance brand running shoes.

In one embodiment, targeted advertisements can be based on the user's own status messages. If a user sends a message to the effect “Nike makes great shoes” the user can be sent advertisements relating to running shoes, including advertisements for Nike brand shoes or competing shoes. The similarities between the user and a specific contact can also be taken into account. For example if the user and contact Alice have a lot of status messages about cats while contact Tom has status messages about dogs we can infer that Alice is more similar to the user. Targeted advertisements that are tailored more towards content messages from Alice instead of the content of messages from Tom.

In one embodiment, targeted advertisements can be sent to a user that relate to topics that are common across multiple contacts. If both Alice and Tom spend a lot of time talking about cars, it can be inferred that it is more likely that the user also likes cars, and the user can be sent targeted advertisements relating to cars. In one embodiment, the targeting of advertisements can be based on social status messages can also be based on the analysis of the social relationships among the status text posters and readers including the strength, type, and/or relevance of the social relationship, as well as additional spatial, temporal, demographic, and topical features.

In one embodiment, users can be given the ability to share or recommend advertisements to the contacts who triggered the advertisements. For example, if a user gets an advertisement for “10% off Amazon” based on a status message where Alice recommended Amazon, the user may be able to forward or share that ad with Alice.

In one embodiment, a system for targeting advertisements based on the user's social context as revealed by the user's status updated context can have a number of advantages:
The system does not require any user input beyond setting up their social network or triggering automated analysis to determine the user's their implicit social graph.
The system can use social status messages as “word of mouth” or viral marketing. Users are more likely to trust a product after seeing a recommendation from a friend.
The system uses public/semi-public data. Status messages are not person-to-person personal messages. In many cases, such as in the case of the Twitter and Pownce messaging services, status messages are either public messages or, at the very least, messages broadcast to an entire social network. This can relieve concerns that third parties may be “snooping” in a user's personal data.
Additionally, users generally see a large number of status messages during a day, which can provide a large inventory of contexts that can be monetized.

The system can be distinguished from other services that provide other types of context based advertisements. For example, Google's Gmail shows contextual ads based on private email messages. Advertisements based on social status messages, on the other hand, represent public or semi-public data and does not create as many privacy concerns. Additionally, status messages are based on a subscription model where a user explicitly asks for status messages from a user rather than email that requires an explicit sending and addressing actions from the sender. Finally, status messages are designed for broadcast, which leads to very different content than an email message.

Some RSS feeds can include advertisements: These are contextual ads that are inserted into an RSS feed by the author of the feed. Such advertisements are based only on the senders context and do not consider the recipient and do not take multiple feeds into account.

Advertisement may be supported by instant messaging (IM) services. For example, Yahoo!'s Messenger YQ provides links that are inserted into IM conversations based on the context of the message. Again, these are personal one-to-one communications and not public status. In the Twitter messaging service, advertisements can be inserted by the sender into their own twitter stream. This does not take the recipient or multiple feeds into consideration.

Advertisements may be placed in discussion forums or BLOG posts. However, such advertisements are based purely on the text content and do not take any social relationships into account. Additionally a discussion forum is generally of less importance to a user than the social network since they are usually closer to the people in their social network.

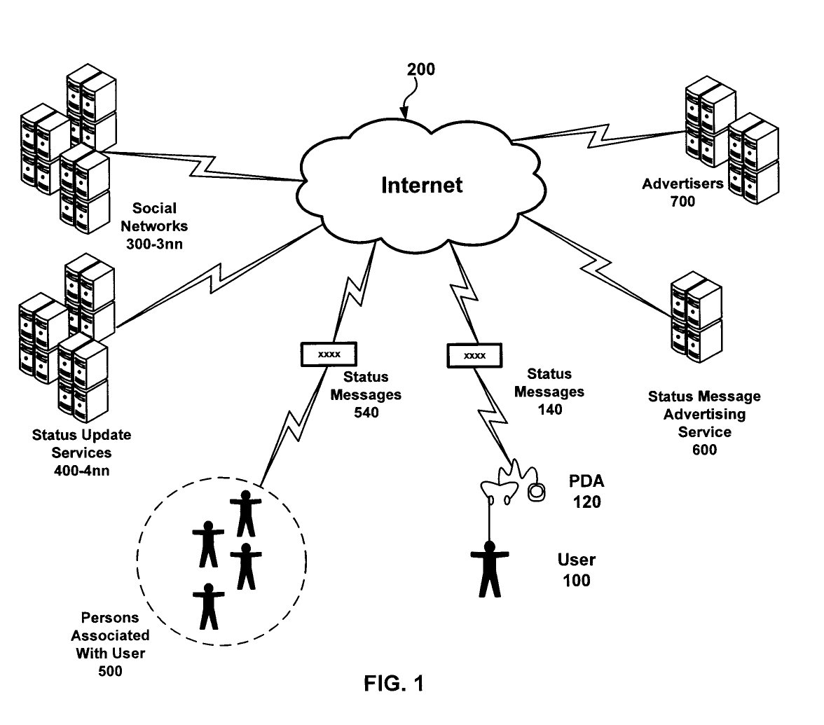

FIG. 1 is a high-level diagram illustrating the components of a system capable of supporting at least one embodiment of a status message based contextual advertising system.

A user 100 is connected to the Internet using a network connectable device 120 such as a PDA, an Internet enabled phone. a laptop or a desktop computer. The user 100 is a member of one or more social networks 300-3nn. Such networks may be defined on social networking websites such as the Facebook, MySpace or LinkedIn websites which, inter alia, allow the user to receive and send status messages. The user 100 may also be a member one or more status update services 400, such as the Twitter websites, which, inter alia, allow the user to receive and send status messages. The user 100 may also utilize other web-based services that allow the user to send and receive messages. Such services can include discussion groups and personal BLOGS that allow readers to post content.

The user is associated with one or more persons 500 in the social networks 300 and the status update services 400. The nature of the associations can vary based on the nature of the social network 300 and the status update services 400, for example, the associations can be friends, relatives or business contacts. However, each person 500 is capable of sending and receiving status messages 520 to the user 100 via the social networks 300 or the status update service, 400 or both. The status messages 520 are public or semipublic, which is to say, they are visible to the general public (public), or to all, or a subset, of the persons 500 the user is associated with (semipublic) on the services 300 and 400. The messages can be messages sent explicitly to the user 100, or may be messages published to a group or messages from a source the user has subscribed to.

The user 100 may access the services 300 and 400 over the Internet 200 periodically to, inter alia, view status messages sent to the user by persons 500 in his or her social networks. The user 100 may send status messages 140 to persons 500 in his or her social networks, either as unsolicited messages, or as responses to messages the user received. On the other hand, the user 100 may never send or reply to status messages. The user 100 can additionally maintain profile information on the websites that is visible to the public or other members of user's social networks. The user can additionally provide additional details about the nature of his or her associations with persons 500 in the user's social networks.

Status messages 140 and 540 sent or received by the user 100 are retrieved, over the Internet, from the services 300 and 400, by a status message based advertising service 600. The status messages 140 and 540 may be retrieved continuously or periodically by the status message based advertising service 600. The user may have explicitly granted the status message based advertising service 600 authority to retrieve his or her status messages 140 and 540. Alternatively, the terms of service of the services 300 and 400 may require the user to consent to retrieval of the user's status messages 140 and 540 by the status message based advertising service 600.

One or more advertisers 700 have accounts with the status message based advertising service 600. The advertisers 700 can define targeted advertisements that are to be sent to persons whose status messages indicate they may be interested in the advertiser's products or services. The user's status messages 140 and 540 are analyzed (described in greater detail below) to determine if one or more targeted advertisements are, or may be, relevant to the user. The selected advertisements are sent to the user 100 using any conventional methodology suitable for the delivery of digital content. For example, the advertisements may be displayed to the user 100 when the user logs on to the on the social networking website 300 or the microblogging website 400. Alternatively, the advertisements could be sent to the user using emails, instant messages or other media.

The status message based advertising service 600 is notified when the user 100 interacts with advertisements which were transmitted to the use by the service. Such interactions could include: displaying the advertisement, mouse over the advertisement, click on the advertisement, double-click on the advertisement, drag and drop the advertisement, resize the advertisement, close the advertisements, and so forth.

Advertisers 700 which created the transmitted advertisements are billed by the status message based adverting service provider 600 based their agreement with the provider. The advertiser 700 can be charged using any conventional Internet advertising billing methodology, which could include cost-per-click (CPC) and cost-per-impression methodologies.

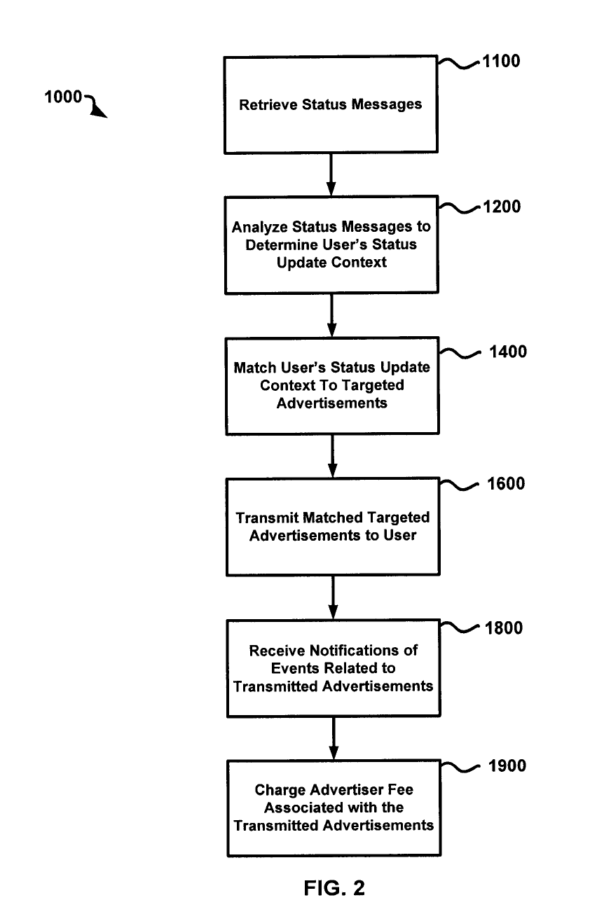

FIG. 2 illustrates one embodiment of a process 100 for social status message based contextual advertising.

A plurality of status messages sent to a user via one or more socially aware messaging services are retrieved 1100, over a network, for example, the Internet. In one embodiment, the user is a member of the socially aware messaging services and has defined at least one social contact to each of the services. Defined social contacts may include any kind of relationship supported by the socially aware messaging services such as, for example, friends, relatives and business contacts. In one embodiment, only messages sent to the user by the user's defined social contacts are retrieved. In one embodiment, status messages sent by the user to one or more of the user's defined social contacts are also retrieved.

In one embodiment, relationships between users can be determined by analyzing the contents of the messages, For example, users that correspond regularly regarding social activities (e.g. meeting for dinner) could be defined as friends.

The messages may be retrieved by any methodology supported by the socially aware messaging services. In one embodiment, the process 1000 may log onto each socially aware messaging service and view the user's messages through the facilities provided by the service to ordinary users (e.g. a profile web page.) In one embodiment, a socially aware messaging service may provide an API through which the process 1000 can retrieve data relating to users of the site. In one embodiment, a socially aware messaging service may provide an RSS feed or other form of pushed data delivery relating to users of the site to the process 1000. The content of the messages can be any form of digital content. Typically, this will include text, but may also include emotive symbols (e.g. “Emoticon” symbols), or graphic or media objects.

The socially aware messaging services from which messages are retrieved may become known to the process 1000 in a number of different ways. A user may explicitly join a status update context based advertising service and define social networking sites or other status message services from which the process 1000 should retrieve messages. Joining a social networking site may automatically enroll the user in a status update context based advertising service. An automated process can additionally retrieve public data available over the Internet to attempt to identify the user's implicit social graph. The user may explicitly grant the process 1000 authority to retrieve his or her status messages 140. Alternatively, the terms of service of one or more of the socially aware messaging services may require the user to consent to retrieval of the user's status messages by a status message based advertising service.

The retrieval process 1100 can be executed periodically, or continuously (i.e. in real-time) to retrieve the user's status messages as frequently as desired. In one embodiment, the retrieval process 1100 may be triggered by an event, such as the user logging onto a social networking website.

The status messages are then analyzed 1200 to determine the user's current status update context. The user's status update context can be broadly defined as the total set of influences the user is exposed to through interaction with his or her current social network and the relative strength of such influences. For example, one of a user's friends may have strong interests or opinions on specific topics, such as a favorite brand of running shoes. The user will be exposed to his or her friends interests, for example, by comments in status messages, and may be influenced by them. If the user's friend is a close friend, the relative strength of such an influence is likely stronger that if the user's friend is a casual acquaintance.

In one embodiment, the user's status update context comprises the total set of social, topical, spatial and temporal data present or implied in status messages that the user sends and receives from his or her contacts through one or more social networking sites.

Social data is data that relates to the strength and type of the relationships between the user and contacts sending messages to the user. The type of the relationship shared between the user and a contact can be explicitly defined on the source socially aware messaging service, e.g. a friend, a relative a co-worker, a business prospect. The type of the relationship shared between the user and a contact can be inferred by the content of messages sent between the user and the contact, e.g. messages relating to business transactions indicate a business relationship.

The strength of a relationship can be explicitly defined on the source social socially aware messaging service, e.g. my best friend. The strength of a relationship can inferred by the frequency of messages sent by a contact to the user or by the frequency with which the user replies to messages sent by the contact. The strength of a relationship can be inferred by commonalties between the user and the contact. For example, the contact and the user can be located in the same geographical area, be approximately the same age or user and the contact may both send messages that relate to the same topic. The strength of a relationship can be inferred by the frequency of contacts between users or by the content of the messages,

Topical data is data related to topics that are discussed in status messages. Topics can refer or relate to persons, such as celebrities, third parties known by the user and the sending contact or specific service providers such as tradesmen or professionals (e.g. doctors, dentists.) Topics can refer or relate to entities such as businesses, sports teams, charitable organizations, restaurants, bars and clubs. Topics can refer or relate to brands or types of consumer products. Topics can refer or relate to abstract ideas or categories such as genres of music, types of literature, religious or philosophical concepts. Topics can refer or relate to the senders emotional state or physical well-being.

Temporal data are data relating to dates and times which are related to the ideas embodied in status messages. Temporal data may relate to current dates and times, may be a specific date and time in the past or the future, or a range of dates and times in the past or the future. Temporal data may relate be an offset from a specific date, for example, ten days in the past. Temporal data may relate to an event on a calendar, such as a birthday, a season or a holiday, or an event in the news, such as the last time a favorite sports team won a championship.

Spatial data is data related to physical locations. Spatial data can relate to a contact's current location. Spatial data can relate to a specific place, such as a country, a state, a city, a neighborhood. Spatial data can relate to the location of an event, such as a concert or some other newsworthy occurrence. Spatial data can relate to a general description of places of interest, such as blues or jazz clubs.

The analysis process 1200 can be executed periodically, or continuously (i.e. in real-time) to update the user's current status update context as frequently as desired. In one embodiment, the analysis process 1200 may be triggered by an event, such as the user logging onto a social networking website.

The user's status update context is then matched 1400 to one or more targeted advertisements. In one embodiment, targeted advertisements are stored on a computer-readable medium and comprise an identification of an advertiser, at least one advertisement (such as a display ad, a flash movie or a text message), and a targeting profile comprising at least one targeting criteria. The targeting criteria may comprise any combination of social, topical, spatial or temporal criteria that defines the status update context of customers to which the advertisement is targeted. In one embodiment the user's status update context is matched to the targeting criteria of targeted advertisements.

Social targeting criteria target specific relationships or patterns of relationships. For example, targeting criteria can target types of relationships such as “friends”, “relatives”, or “business prospects”. Targeting criteria can target relationships which appear to be strong relationships, e.g. “best friends”, contacts which appear to share many interests in common with the user or contacts to whose messages the user responds to frequently.

Topical targeting criteria target specific topics or generic topics. For example, specific topics can relate to a specific person, e.g. a specific musical artist, or a generic type of person, e.g. all musical artists. Targeting criteria can target specific entities such as a specific business or organization, or can relate to generic types of entities such as businesses, sports teams, charitable organizations, restaurants, bars and clubs. Targeting criteria can target specific brands or generic types of consumer products. Targeting criteria can target abstract ideas or categories of abstract ideas such as genres of music, types of literature, religious or philosophical concepts. Targeting criteria can target the sender's apparent emotional state or apparent physical well-being.

Topical targeting criteria target specific or relative dates and times. Topical targeting criteria target can target current dates and times, can target a specific date and time in the past or the future, or can target a range of dates and times in the past or the future. Temporal targeting criteria can target a specific date, for example, ten days in the past. Temporal targeting criteria can target a an event on a calendar, such as a birthday, a season or a holiday, or an event in the news, such as the last time a favorite sports team won a championship.

Spatial targeting criteria target specific or generic physical locations. Spatial targeting criteria can target a specific contact's current location. Spatial targeting criteria can target a specific place, such as a country, a state, a city, a neighborhood. Spatial targeting criteria can target the location of an event, such as a concert or some other newsworthy occurrence. Spatial targeting criteria can target generic types of places of interest, such as blues or jazz clubs.

Targeting criteria can additionally include data frequency or distribution criteria. Data frequency criteria can specify that a specific social, topical, temporal or spatial targeting criteria or set of criteria must appear in at least a threshold number of messages. For example, an automobile manufacturer may only wish to target users who have received at least 10 automobile related messages in the last month. Data distribution criteria can specify that a specific social, topical, temporal or spatial targeting criteria must appear in a group of messages having specific statistical properties. For example, a music download service may only wish to target users who have received at least 10 messages from at least three different contacts the user has defined as friends. In another example, a travel service may only wish to target users who have received at least 10 messages related to travel from at least two different social networking sites.

The matching process 1400 can be executed periodically, or continuously (i.e. in real-time) to match the user's current status update context to targeted advertisements as frequently as desired. In one embodiment, the matching process 1400 may be triggered by an event, such as the user logging onto a social networking website.

The matched targeted advertisements are then transmitted to the user 1600. The matched targeted advertisements can be sent to the user using any conventional methodology suitable for the delivery of digital content. For example, the advertisements may be displayed to the user when the user logs on to a social networking website or a microblogging website. Alternatively, the advertisements could be sent to the user using emails, instant messages, SMS or other media.

Advertisements can include social graph information that triggered the advertisements. In one embodiment, the contacts whose messages triggered the advertisement can be displayed with the advertisement, either automatically, or on the occurrence of a user interface event, e.g. right-clicking on the advertisement. In one embodiment, the user could share or recommend the advertisement to contacts that triggered the advertisement.

The process receives notifications of user interface events 1800 related to the transmitted advertisements when the user displays or otherwise interacts with the advertisements. Such events could include: displaying an advertisement, mouse over an advertisement, click on an advertisement, double-click on an advertisement, drag and drop an advertisement, resize an advertisement, close an advertisements, and so forth.

In one embodiment, at least some of the targeted advertisements additionally comprise a fee that is assessed to the advertiser when a user interface event related to the advertisement occurs. In such a case, the advertiser that created the targeted advertisement is charged the fee 1900 when a notification that the user interface event occurred is received. In one embodiment, advertisers can be charged using any conventional Internet advertising billing methodologies, which could include cost-per-click (CPC) and cost-per-impression methodologies.

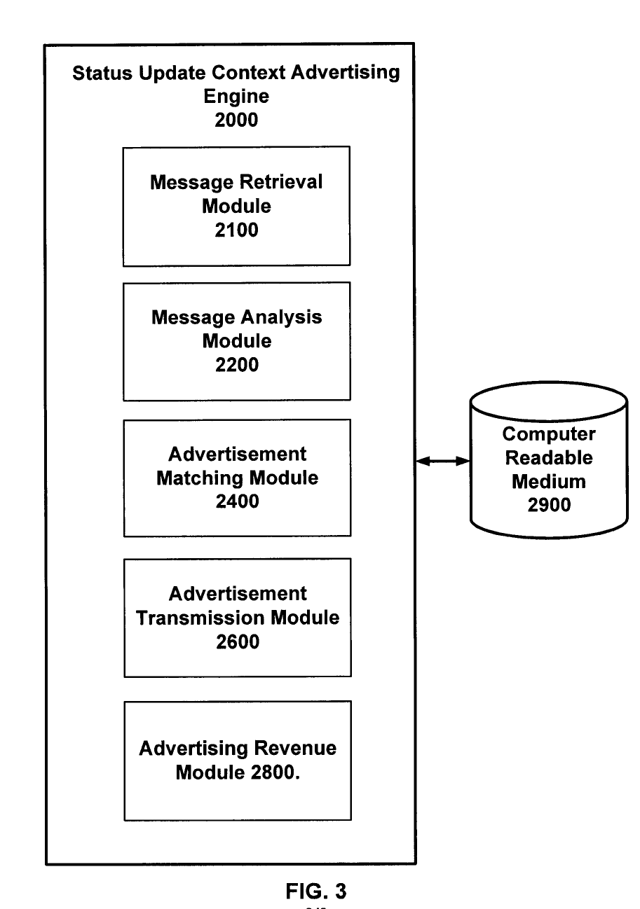

FIG. 3 illustrates one embodiment of a status update context advertising engine 2000 which is capable of supporting the social status message based contextual advertising process illustrated in FIG. 2 In one embodiment, the status update context advertising engine 2000 could be hosted by a server provided by the status message based advertising service 600 of FIG. 1.

The status update context advertising engine 2000 comprises: a message retrieval module 2100, a message analysis module 2200, an advertisement matching module 2400, an advertisement transmission module 2600 and an advertising revenue module 2800. In one embodiment, the modules are computer executable code stored on a computer-readable medium.

The message retrieval module 2200 is configured to retrieve, over a network, a plurality of status messages sent to a user via at least one socially aware messaging service, where the user is a member of the socially aware messaging services and has defined at least one social contact on services, and where each of the status messages was sent to the user by one at least one of the user's social contacts. The status messages retrieved by the message retrieval module 2200 can additionally include status messages sent by the user, via socially aware messaging services, to at least one of the user's social contacts.

The message analysis module 2200 is configured to analyze the status messages retrieved by the message retrieval module to determine the user's status update context. In one embodiment, the user's status update context comprises a set of social, topical, spatial and temporal data present in the plurality of status messages that the user sends and receives from his or her contacts through one or more socially aware messaging services.

In one embodiment, the social data in the user's status update context comprises data relating to the strength and type of relationships between the user and the social contacts that sent status messages to the user. In one embodiment, the strength of a relationship between the user and a social contact can be determined by the message analysis module using a definition of the relationship maintained by the user on the at least one social networking site.

In one embodiment, the strength of a relationship between a user and a social contact is determined by the message analysis module 2200 using a definition of the relationship maintained by the user on a social networking site. In one embodiment, the strength of the relationship between a user and a social contact is determined by the message analysis module using the frequency of messages between a user and the social contact. In one embodiment, the strength of the relationship between the user a social contact is determined by the message analysis module using the similarity of topical data in status messages sent by the user and by the at least one social contact.

In one embodiment, the topical data in the user's status update context comprises data related to topics that are discussed in the status messages retrieved by the message retrieval module 2200. In one embodiment, the temporal data in the user's status update context comprises data relating to dates and times in the status messages retrieved by the message retrieval module 2200. In one embodiment, the spatial data in the user's status update context comprises data relating to physical locations in the status messages retrieved by the message retrieval module 2200.

The advertisement matching module 2400 is configured to match the user's status update context (as determined by the message analysis module) to at least one targeted advertisement stored on a computer-readable medium. In one embodiment, each targeted advertisement comprises an identification of an advertiser, at least one advertisement (such as a display ad, text ad or flash movie), and a targeting profile comprising at least one targeting criteria. The targeting criteria are matched to the user's status update context.

The targeting criteria can include social targeting criteria, targeting topical criteria, temporal targeting criteria and spatial targeting criteria. The at least one targeting criteria can include at least one data frequency criteria. For example, a data frequency criteria can specify a threshold number of status messages retrieved by the message retrieval module 2200 must relate to a specific social targeting criteria, topical targeting criteria, temporal targeting criteria or spatial targeting criteria.

The targeting criteria can include data distribution criteria. For example, a data distribution criteria could specify that a specific social targeting criteria, topical targeting criteria, temporal targeting criteria, or spatial targeting criteria must appear in a threshold number of the status messages retrieved by the message retrieval module 2200 from at least two the user's social contacts. A data distribution criteria could also specify that a specific social targeting criteria, topical targeting criteria, temporal targeting criteria or spatial targeting criteria must appear in a threshold number of the status messages retrieved by the message retrieval module 2200 from at least two socially aware messaging services.

The advertisement transmission module 2600 is configured to transmit the matched targeted advertisements, over the network, to the user. The matched targeted advertisements can be sent to the user using any conventional methodology suitable for the delivery of digital content. For example, the advertisements may be displayed to the user when the user logs on to a social networking website. Alternatively, the advertisements could be sent to the user using emails, instant messages or other media.

In one embodiment, at least some targeted advertisements additionally include a fee that is assessed to the advertiser when a user interface event related to the targeted advertisements occur. In one embodiment, the advertising revenue module 2800 is configured to receive, over the network, notifications that user interface event related to a targeted advertisement has occurred to charge the advertising fee to the advertiser that placed the advertisement.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method comprising the steps of:
retrieving, over a network, a plurality of status messages sent to a user via at least one status update service, wherein the user is a member of the at least one status update service and has defined at least one social contact on the at least one status update service, and wherein each of the plurality of status messages was sent to the user by one of the at least one social contacts;
analyzing the plurality of status messages, using at least one computing device, to determine the user's status update context, wherein the user's status update context comprises a set of social, topical, spatial and temporal data present in the plurality of status messages;
matching the user's status update context, using the at least one computing device, to at least one targeted advertisement stored on a computer-readable medium; and
transmitting the at least one targeted advertisement, over the network, to the user.

2. The method of claim 1 wherein the at least one targeted advertisement additionally comprises a fee that is assessed to the advertiser when a user interface event related to the at least one targeted advertisement occurs, the method comprises the additional steps of:
receiving, over the network, a notification that the user interface event related to the at least one targeted advertisement has occurred; and
charging the fee to advertiser, using at least one computing device.

3. The method of claim 1, wherein the plurality of status messages additionally comprises status messages sent by the user, via the at least one status update service, to at least one of the user's social contacts.

4. The method of claim 1 wherein each targeted advertisement comprises an identification of an advertiser, at least one advertisement, and a targeting profile comprising at least one targeting criteria, wherein the user's status update context matches targeting criteria associated with at least one targeted advertisement.

5. The method of claim 3,
wherein the social data in the user's status update context comprises data relating to the strength and type of relationships between the user and at least one social contact which sent each of the plurality of status messages to the user;
wherein the topical data in the user's status update context comprises data related to topics which are discussed in the plurality of status messages;
wherein the temporal data in the user's status update context comprises data relating to dates and times in the plurality of status messages; and
wherein the spatial data in the user's status update context comprises data relating to physical locations in the plurality of status messages.

6. The method of claim 5 wherein the strength of the relationship between the user and the at least one social contact is determined by a definition of the relationship maintained by the user on the at least one social networking site.

7. The method of claim 5 wherein the strength of the relationship between the user and the at least one social contact is determined by the frequency of messages between the user and the at least one social contact.

8. The method of claim 5 wherein the strength of the relationship between the user and the at least one social contact is determined by the similarity of topical data in status messages sent by the user and by the at least one social contact.

9. The method of claim 4 wherein the at least one targeting criteria is selected from the list: social targeting criteria, targeting criteria, temporal targeting criteria, and spatial targeting criteria.

10. The method of claim 4 wherein the at least one targeting criteria comprise at least one social targeting criteria, at least one topical targeting criteria, at least one temporal targeting criteria, and at least one spatial target criteria.

11. The method of claim 9 wherein the at least one targeting criteria comprises at least one data frequency criteria, wherein the at least one data frequency criteria specifies a threshold number of the plurality of status messages that must relate to a specific social targeting criteria, topical targeting criteria, temporal targeting criteria, or spatial targeting criteria.

12. The method of claim 9 wherein the at least one targeting criteria comprises at least one data distribution criteria, wherein the at least one data distribution criteria specifies that a specific social targeting criteria, topical targeting criteria, temporal targeting criteria, or spatial targeting criteria must appear in a threshold number of the plurality of messages from at least two of the at least one social contacts.

13. The method of claim 9 wherein the at least one targeting criteria comprises at least one data distribution criteria, wherein the at least one data distribution criteria specifies that a specific social targeting criteria, topical targeting criteria, temporal targeting criteria, or spatial targeting criteria must appear in a threshold number of the plurality of messages from at least two of at least one social networking sites.

14. The method of claim 1 wherein the at least one targeted advertisements are displayed to the user on a display device when the user logs on to the at least one status update service.

15. The method of claim 1 wherein the at least one targeted advertisements are sent to the user using emails, instant messages or SMS.

16. The method of claim 1 wherein the at least one targeted advertisement further comprises an identification of at least one of the user's at least one social contacts, wherein the at least one targeted advertisement was matched to the user's status update context due to at least one of the plurality of status messages which was sent to the user by the user's at least one social contact.

17. The method of claim 16 comprising the additional step of:
forwarding the at least one targeted advertisement, over the network, to the at least one of the user's at least one social contacts.

18. A system comprising:
a message retrieval module that retrieves, over a network, a plurality of status messages sent to a user via at least one status update service, wherein the user is a member of the at least one status update service and has defined at least one social contact on the at least one status update service, and wherein each of the plurality of status messages was sent to the user by one of the at least one social contacts
a message analysis module that analyzes the plurality of status messages retrieved by the message retrieval module to determine the user's status update context, wherein the user's status update context comprises a set of social, topical, spatial and temporal data present in the plurality of status messages;
an advertisement matching module that matches the user's status update context determined by the message analysis module to at least one targeted advertisements stored on a computer-readable medium; and
an advertisement transmission module that transmits the at least one targeted advertisement, over the network, to the user.

19. The system of claim 18 wherein the at least one targeted advertisement additionally comprises a fee that is assessed to the advertiser when a user interface event related to the at least one targeted advertisement occurs, the system additionally comprising:
an advertising revenue module that receives, over the network, a notification that the user interface event related to the at least one targeted advertisement has occurred and charges the fee to advertiser.

20. The system of claim 18 wherein the plurality of status messages additionally comprise status messages sent by the user, via the at least one social networking website, to at least one of the user's social contacts.

21. The system of claim 18 wherein each targeted advertisement comprises an identification of an advertiser, at least one advertisement, and a targeting profile comprising at least one targeting criteria, wherein the user's status update context matches targeting criteria associated with at least one targeted advertisement;

22. The system of claim 20,
wherein the social data in the user's status update context comprises data relating to the strength and type of relationships between the user and at least one social contact which sent each of the plurality of status messages to the user;
wherein the topical data in the user's status update context comprises data related to topics which are discussed in the plurality of status messages;
wherein the temporal data in the user's status update context comprises data relating to dates and times in the plurality of status messages; and
wherein the spatial data in the user's status update context comprises data relating to physical locations in the plurality of status messages.

23. The system of claim 22 wherein the strength of the relationship between the user and the at least one social contact is determined by the message analysis module using a definition of the relationship maintained by the user on the at least one social networking site.

24. A computer-readable medium having computer-executable instructions for a method comprising the steps of:
retrieving, over a network, a plurality of status messages sent to a user via at least one status update service, wherein the user is a member of the at least one status update service and has defined at least one social contact on the at least one status update service, and wherein each of the plurality of status messages was sent to the user by one of the at least one social contacts;
analyzing the plurality of status messages, using at least one computing device, to determine the user's status update context, wherein the user's user's status update context comprises a set of social, topical, spatial and temporal data present in the plurality of status messages;
matching the user's status update context, using the at least one computing device, to at least one targeted advertisement stored on a computer-readable medium;
transmitting the at least one targeted advertisement, over the network, to the user.

25. The computer-readable medium of claim 24 wherein the at least one targeted advertisement additionally comprises a fee that is assessed to the advertiser when a user interface event related to the at least one targeted advertisement occurs, the computer-readable medium comprises the additional steps of:
receiving, over the network, a notification that the user interface event related to the at least one targeted advertisement has occurred; and
charging the fee to advertiser, using at least one computing device.

26. The computer-readable medium of claim 24 wherein the plurality of status messages additionally comprises status messages sent by the user, via the at least one social networking website, to at least one of the user's social contacts.

27. The computer-readable medium of claim 24 wherein each targeted advertisement comprises an identification of an advertiser, at least one advertisement, and a targeting profile comprising at least one targeting criteria, wherein the user's status update context matches targeting criteria associated with at least one targeted advertisement.

28. The computer-readable medium of claim 26,
wherein the social data in the user's status update context comprises data relating to the strength and type of relationships between the user and at least one social contact which sent each of the plurality of status messages to the user;
wherein the topical data in the user's status update context comprises data related to topics which are discussed in the plurality of status messages;
wherein the temporal data in the user's status update context comprises data relating to dates and times in the plurality of status messages; and
wherein the spatial data in the user's status update context comprises data relating to physical locations in the plurality of status messages.

29. The computer-readable medium of claim 28 wherein the strength of the relationship between the user and the at least one social contact is determined by a definition of the relationship maintained by the user on the at least one social networking site.

30. The computer-readable medium of claim 28 wherein the strength of the relationship between the user and the at least one social contact is determined by the frequency of messages between the user and the at least one social contact.

31. The computer-readable medium of claim 28 wherein the strength of the relationship between the user and the at least one social contact is determined by the similarity of topical data in status messages sent by the user and by the at least one social contact.

32. The computer-readable medium of claim 27 wherein the at least one targeting criteria is selected from the list: social targeting criteria, targeting criteria, temporal targeting criteria, and spatial targeting criteria.

33. The computer-readable medium of claim 27 wherein the at least one targeting criteria comprise at least one social targeting criteria, at least one topical targeting criteria, at least one temporal targeting criteria, and at least one spatial target criteria.

34. The computer-readable medium of claim 24 wherein the at least one targeted advertisement further comprises an identification of at least one of the user's at least one social contacts, wherein the at least one targeted advertisement was matched to the user's status update context due to at least one of the plurality of status messages which was sent to the user by the user's at least one social contact.

35. The computer-readable medium of claim 34 comprising the additional step of:
forwarding the at least one targeted advertisement, over the network, to the at least one of the user's at least one social contacts.
